(19) United States
(12) Patent Application Publication
(10) Pub. No.: US 2021/0142355 A1
(43) Pub. Date: May 13, 2021

(54) ADVERTISEMENT EFFECTIVENESS DETERMINATION

(71) Applicant: FIREFLY SYSTEMS INC., San Francisco, CA (US)

(72) Inventors: Vedat Taylan YILDIZ, San Mateo, CA (US); Kaan GUNAY, San Francisco, CA (US); Onur KARDESLER, San Francisco, CA (US); Anup Prabhakar DHALWANI, New York City, NY (US)

(21) Appl. No.: 16/781,849

(22) Filed: Feb. 4, 2020

Related U.S. Application Data
(60) Provisional application No. 62/933,919, filed on Nov. 11, 2019.

(51) Int. Cl. G06Q 30/02

(52) U.S. Cl. CPC G06Q 30/0243; G06Q 30/0246; G06Q 30/0277; G06Q 30/0266

(57) ABSTRACT

The present disclosure provides operations for determining an effectiveness of an advertisement. The operations may include determining a first rate of engagement with a product, service, or message by a target group that includes one or more subjects who had an opportunity to view an advertisement for the product, service, or message at a specified location during a first time period. The operations may further include determining a second rate of engagement with the product, service, or message by a control group that includes one or more subjects present at the specified location during a second time period disjoint from the first time period and who did not have an opportunity to view the advertisement for the product, service, or message. The operations may further include determining the effectiveness of the advertisement using the first rate of engagement and the second rate of engagement.

### CROSS REFERENCE TO RELATED APPLICATION

This application claims the benefit of U.S. Patent Application Ser. No. 62/933,919, filed on Nov. 11, 2019; the disclosure of which is incorporated herein by reference in its entirety.

### FIELD

The embodiments discussed in the present disclosure are related to determining the effectiveness of advertisements.

### BACKGROUND

Advertisers may measure the effectiveness of an advertisement by comparing the rate of engagement of a target group with the subject matter of the advertisement to the rate of engagement of a control group with the subject matter of an advertisement. The target group may be a group of people who saw or had the opportunity to see the advertisement. The control group may be a group of people who did not have an opportunity to see the advertisement or a random group of people selected from a population. A higher rate of engagement by the target group may indicate that the advertisement was effective.

### SUMMARY

In one aspect, the present disclosure provides operations for determining an effectiveness of an advertisement. The operations may include determining a first rate of engagement with a product, service, or message by a target group. The target group may include one or more subjects who had an opportunity to view an advertisement for the product, service, or message at a specified location during a first time period. The operations may further include determining a second rate of engagement with the product, service, or message by a control group. The control group may include one or more subjects present at the specified location during a second time period who did not have an opportunity to view the advertisement for the product, service, or message. The first time period and the second time period may be disjoint. The operations may further include determining the effectiveness of the advertisement using the first rate of engagement by the target group and the second rate of engagement by the control group.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the invention are utilized, and the accompanying drawings (also “Figure” and “FIG.” herein), of which:

FIG. 1 schematically illustrates a system for determining an effectiveness of an advertisement, in accordance with one or more implementations;

FIG. 2 is a flow chart of an example process for determining an effectiveness of an advertisement, in accordance with one or more implementations;

FIG. 3 illustrates an example presentation system for displaying media content; and

FIG. 4 illustrates an example computing system that is programmed or otherwise configured to implement methods provided herein.

### DETAILED DESCRIPTION

While various embodiments of the present disclosure have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The present disclosure provides systems, methods, and computer program products for determining the effectiveness of an advertisement. The systems described herein can determine the effectiveness of an advertisement or other messaging (e.g., political messages, public service announcements, non-profit organization messages of all sorts, etc.) by determining a first rate of engagement with the subject matter of the advertisement by a target group. The target group may be a group of subjects who saw or had an opportunity to see the advertisement at a specified location during a first time period. The first rate of engagement may be the proportion of the target group that interacted with the subject matter of the advertisement (e.g., bought a product shown in the advertisement, used a service shown in the advertisement, visited a location shown in the advertisement, etc.) within a predetermined time period after having the opportunity to see the advertisement. The system can determine the first rate of engagement by using, for example, survey data, location data, mobile and device-based behavior, or Internet purchase histories of the subjects in the target group. The systems described herein can additionally determine a second rate of engagement with the subject matter of the advertisement by a control group. The control group may be a group of subjects who did not have an opportunity to view the advertisement. The control group may be a group of subjects, for example, who were present at the specified location during a second time period during which the advertisement was not visible or not present at the specified location. The first time period and the second time period may be disjoint. That is, the two time periods may not overlap. The system can determine the effectiveness of the advertisement by using the first rate of engagement and the second rate of engagement. For example, the system can divide the first rate of engagement by the second rate of engagement to determine an engagement factor.

The system described above can more accurately determine the effectiveness of an advertisement by identifying and using demographically similar, psychographically similar, and/or behaviorally similar target and control groups. Groups in the same location, but at slightly different times, may be more similar than groups in different locations at the same time. As such, the present disclosure provides a mechanism for identifying and distinguishing between similar target and control groups to better determine the effectiveness of an advertisement.

Additionally, the system described above can more accurately determine the effectiveness of a moving advertisement than conventional methods. Conventional methods may build control groups by selecting subjects at a location that is determined to be comparable to the location of the advertisement. However, the subjects at the selected location may not be sufficiently demographically similar to the target group that was exposed to the advertisement, which may result in biased effectiveness measurements. The system described herein can build demographically similar or identical control groups for moving advertisements by identifying and selecting subjects at the same location as the advertisement after the advertisement has moved to another location. In some cases, the systems described herein can identify control groups that are identical or nearly identical to the target group in past purchase behavior, store visit behavior, and the like.

FIG. 1 schematically illustrates a system 100 that is configured to determine the effectiveness of an advertisement. The system 100 can have a group determination subsystem 110, a rate engagement determination subsystem 120. The system 100 can receive data from data sources 130, which may include the display screen that shows the advertisement, electronic devices in the vicinity of the advertisement, and third-party data providers. The system 100 can be implemented one or more appropriately-programmed computers in one or more locations.

The group determination subsystem 110 may include code and routines configured to enable a computing device to perform one or more operations with respect to identifying groups of subjects. Additionally or alternatively, the group determination subsystem 110 may be implemented using hardware including a processor, a microprocessor (e.g., to perform or control performance of one or more operations), a field-programmable gate array (FPGA), or an application-specific integrated circuit (ASIC). In some other instances, the group determination subsystem 110 may be implemented using a combination of hardware and software. In the present disclosure, operations described as being performed by the group determination subsystem 110 may include operations that the group determination subsystem 110 may direct a corresponding system (e.g., a computing system that includes the group determination subsystem 110) to perform.

The group determination subsystem 110 can determine subjects that belong to a target group and subjects that belong to a control group. The target group may include subjects that viewed or had the opportunity to view an advertisement at a specified location during a first time period. The control group may include subjects that did not have an opportunity to view the advertisement, e.g., because they were not present at the specified location during the first time period. The control group may instead include subjects that were present at the specified location during a second time period that does not overlap with (i.e., is disjoint from) the first time period.

The group determination subsystem 110 can obtain data defining the location of both the advertisement and a plurality of subjects. The location data may indicate, for example, the global positioning system coordinates (GPS) or address of the advertisement and the subjects over time. For example, the location data may indicate geographic locations at which the advertisement is displayed and corresponding times as to when the advertisement is displayed at the respective geographic locations.

In some embodiments the advertisement may be displayed on a billboard and the GPS coordinates or address of the billboard and corresponding times of displaying of the advertisement may be used to obtain the location data. Additionally or alternatively, the advertisement may be displayed on or in a vehicle (e.g., via a display screen attached to the vehicle, printed on the vehicle, etc.) and GPS coordinates of the vehicle and corresponding timestamps may be obtained to obtain the location data. The vehicle GPS coordinates may be obtained via an electronic device of an operator or passenger of the vehicle or a GPS sensor and transmitter that may be integrated with the vehicle in some embodiments. Additionally or alternatively, the group determination subsystem 110 can obtain location data of the advertisement directly from the display screen that shows the advertisement. The display screen may have an integrated GPS sensor and transmitter. The transmitter can continuously or periodically transmit location data to the group determination subsystem 110. The group determination subsystem 110 can obtain location data of the plurality of subjects from the subjects' electronic device data. The location data may indicate geographic locations of the respective electronic devices and corresponding times as to when the respective electronic devices are located at the geographic locations. The group determination subsystem 110 can obtain the location data directly from the subjects' electronic devices or from a third-party provider of electronic device data. The location data may be anonymized, i.e., not associated with a particular person.

The electronic devices may include any suitable electronic device that may communicate associated electronic device data that may be used in determining groups and/or engagement with subject matter. For example, the electronic devices may include portable electronic devices such as a mobile device (e.g., mobile telephone), an electronic tablet, a laptop, or any other suitable device.

The group determination subsystem 110 can determine subjects that belong to the target group by comparing the location data of each of the plurality of subjects to the location data of the advertisement during the time period during which the advertisement was being displayed.

The group determination subsystem 110 can determine subjects that belong to the control group in substantially the same way, except that the relevant time period may be before or after the time period during which the advertisement was playing or present at the specified location. The beginning of such time period may be at least about 30 seconds, 1 minute, 5 minutes, 10 minutes, 30 minutes, 1 hour, 2 hours 3 hours, 4 hours, 5 hours, 10 hours, 20 hours, 1 day, or more after the advertisement is no longer displayed. In some cases, the time period may be less than 30 seconds. The time period may vary depending on different use cases and the above examples are not meant to be limiting.

In these or other embodiments, the group determination subsystem may further identify subjects who have similar demographic, behavior, or psychological profiles as the subjects of the target group. For example, based on the Internet history, included in the electronic device data, demographic, behavioral and/or psychological profiles of the subjects of the target group and of the subjects of the control group may be identified. In some embodiments, the target group and the control group may be divided into sub-groups that have similar demographic, behavioral, and/or psychological profiles.

The engagement rate determination subsystem 120 may include code and routines configured to enable a computing device to perform one or more operations with respect to identifying engagement by the subject groups with respect to products or services that correspond to displayed advertisements. Additionally or alternatively, the engagement rate determination subsystem 120 may be implemented using hardware including a processor, a microprocessor (e.g., to perform or control performance of one or more operations), a field-programmable gate array (FPGA), or an application-specific integrated circuit (ASIC). In some other instances, the engagement rate determination subsystem 120 may be implemented using a combination of hardware and software. In the present disclosure, operations described as being performed by the engagement rate determination subsystem 120 may include operations that engagement rate determination subsystem 120 may direct a corresponding system (e.g., a computing system that includes the engagement rate determination subsystem 120) to perform.

The engagement rate determination subsystem 120 can obtain identifiers of the subjects belonging to the target group and the control group from the group determination subsystem 110. The engagement rate determination subsystem 120 can determine whether each subject engaged with the subject matter of the advertisement and compute an aggregate rate of engagement for both the target group and the control group. In these or other embodiments, the engagement rate determination subsystem 120 may determine the engagement rate of sub-groups of the target group and the control group such as sub-groups divided according to demographics, behavior, and/or psychological profiles.

A subject may engage with the subject matter of an advertisement when he purchases or uses an advertised product or service, is present at a location that sells or offers an advertised product or service, conducts an Internet search for the advertised product or service, or the like. The engagement rate determination subsystem 120 can determine whether a particular subject engaged with the subject matter of an advertisement in such ways by using data from the subject's electronic device, e.g., Internet purchase history, Internet activity data, or location data. The engagement rate determination subsystem 120 can determine the rate of engagement for the target group or control group by dividing the number of people in the group that engaged with the subject matter of the advertisement by the total number of people in the group.

The subsystems of FIG. 1 and their components can be implemented on one or more computing devices. The computing devices can be servers, desktop or laptop computers, electronic tablets, mobile devices, or the like. The computing devices can be located in one or more locations. The computing devices can have general-purpose processors, graphics processing units (GPU), application-specific integrated circuits (ASIC), field-programmable gate-arrays (FPGA), or the like. The computing devices can additionally have memory, e.g., dynamic or static random-access memory, read-only memory, flash memory, hard drives, or the like. The memory can be configured to store instructions that, upon execution, cause the computing devices to determine the effectiveness of an advertisement. The computing devices can additionally have network communication devices. The network communication devices can enable the computing devices to communicate with each other and with any number of user devices, over a network. For example, the network communication devices can allow the computing devices that implement the system 100 to communicate with subjects' electronic devices and the display screen that shows the advertisement. The network can be a wired or wireless network. For example, the network can be a fiber optic network, Ethernet® network, a satellite network, a cellular network, a Wi-Fi® network, a Bluetooth® network, or the like. In other implementations, the computing devices can be several distributed computing devices that are accessible through the Internet. Such computing devices may be considered cloud computing devices.

Modifications, additions, or omissions may be made to FIG. 1 without departing from the scope of the present disclosure. For example, the system 100 may include more or fewer elements than those illustrated and described in the present disclosure. Moreover, the group determination subsystem 110 and the engagement rate determination subsystem 120 may be integrated into a single subsystem or system in some embodiments. The delineation between the two in the present disclosure is merely to help aid in understanding of the functions and operations that may be performed and is not meant to be limiting.

FIG. 2 is a flow chart of an example process 200 for determining the effectiveness of an advertisement. The process 200 can be performed by the system 100 of FIG. 1, which may be implemented on one or more appropriately-programmed computers in one or more locations.

The system can determine a first rate of engagement with the subject matter of an advertisement (e.g., a product, service, or message) by a target group (210). The target group may include one or more subjects who had an opportunity to view the advertisement at a specified location during a first time period, e.g., because such subjects were present at or near the specified location during the first time period. The specified location may be a city block or a particular street on a city block.

Determining the first rate of engagement may involve determining the proportion of the target group that engaged in an online or offline activity of interest to an advertiser associated with the advertisement. For example, determining the first rate of engagement may involve determining a proportion of the target group that purchased an advertised product or service within a specified period of time. The specified period of time may be at least about 1 hour, 2 hours, 3 hours, 4 hours, 5 hours, 10 hours, 20 hours, 1 day, 2 days, 3 days, 4 days, 5 days, 1 week, 2 weeks, 3 weeks, 4 weeks, 1 month, or more. Additionally or alternatively, the specified period of time may be modified according to individual use cases and the above examples are not limiting. For example, the specified time period may be greater than or less than those indicated above. Determining the first rate of engagement may additionally or alternatively involve determining a proportion of the target group that engaged with a corresponding online advertisement (e.g., clicked on or viewed the online advertisement) for the product, service, or message within a specified period of time. Determining the first rate of engagement may additionally or alternatively involve determining the proportion of the target group that visited a point of interest within a specified period of time. The point of interest may be associated with the message of the advertisement, or it may be a store that sells or offers an advertised product or service. For example, if the advertisement was for a fast food chain, the system can determine the proportion of the target group that visited the fast food chain within the specified period of time. In general, the online or offline activity may be the purchase or use of an advertised product or service, a visit to a location that sells or offers the advertised product or service, conducting an Internet search for the advertised product or service, clicking an online advertisement or link for the advertised product or service, downloading an advertised application, or the like.

The system can use electronic device data to identify subjects that belong to the target group. For example, the system can determine that a particular person belongs to the target group by determining, using location data from such person's phone, that the person was located within a specified distance of the advertisement during the first time period, i.e., the time period during which the advertisement was being displayed. The specified distance may be at most about 1000 feet, 500 feet, 250 feet, 100 feet, 50 feet, 40 feet, 30 feet, 20 feet, 10 feet, 5 feet, or less. In some cases, the specified distance may be more than 1000 feet. The specified distance may be variable based on characteristics of the advertisement, e.g., the size or length (in time) of the advertisement. The specified distance may define a region around the advertisement. The region may be circular, triangular, rectangular, pentagonal, hexagonal, or any other shape.

The system can also use electronic device data from the subjects identified as belonging to the target group to determine whether such subjects engaged with the subject matter of the advertisement. For example, the system can use (i) location data from the subjects' electronic devices to determine whether they visited points of interest, (ii) Internet history from the subjects' electronic devices to determine whether they conducted searches for the subject matter of the advertisement or clicked on or viewed related online advertisements, (iii) and Internet purchase history from the subjects' electronic devices to determine whether they purchased a product, service, or application that was the subject of the advertisement. The system can obtain the electronic device data from the subjects' electronic devices directly, or it can obtain the electronic device data from third-party providers. The electronic device data for a particular subject may be associated with an identification number so that the subject's location, purchases, and Internet activity can be tracked over time. However, the electronic device data may be anonymized, i.e., not associated with any personally identifying information. In some cases, the system can use location data from potential subjects' electronic devices to predict whether such subjects will belong to the target group or control group. The system can also use survey data to determine whether a subject engaged with the subject matter of the advertisement. The survey data may include responses from members of the target group that indicate whether they engaged with the subject matter of the advertisement, e.g., purchased an advertised product.

The system can determine a second rate of engagement with the product, service, or message by a control group (220). The control group can include one or more subjects located at the specified location during a second time period who did not have an opportunity to view the advertisement for the product, service, or message. The first time period and the second time period may be disjoint. That is, the two time periods may not overlap. The difference between the end of the first time period and the beginning of the second time period may be at most about 1 hour, 30 minutes, 15 minutes, 10 minutes, 5 minutes, 1 minute or less. In some cases, the difference may be more than 1 hour. In some cases, the difference may be at least 5 minutes. In general, the difference may be large enough such that the members of the control group do not have an opportunity to view the advertisement but small enough such that the target group and the control group satisfy a demographic similarity criterion. The demographic similarity criterion may indicate the level of similarity of one or more demographic features (e.g., race, ethnicity, nationality, age, sex, gender, religion, residency, occupation, etc.) between the target and control groups. The system can more accurately determine the effectiveness of an advertisement by using demographically similar target and control groups. Groups in the same location, but at slightly different times, may be more similar than groups in different locations at the same time.

The system can determine members of the control group and whether such members engaged in the subject matter of the advertisement in substantially the same way as the target group.

In some cases, a subject may move from the control group to the target group by being exposed to the advertisement at some point in the future. In such cases, the system can discard the subject's data or recalculate the rates of engagement of the target and control groups.

The system can determine the effectiveness of the advertisement using the first rate of the engagement by the target group and the second rate of engagement by the control group (230). For example, the system can divide the first rate of engagement by the second rate of engagement or subtract the second rate of engagement from the first rate of engagement. In general, the first rate of engagement being higher than the second rate of engagement may indicate that the advertisement was effective.

The system can output a report indicative of the effectiveness of the advertisement (240). The report may contain the subject matter of the advertisement, the location(s) of the advertisement, data about the target and control groups (e.g., the size of the groups and demographic information about the groups), the first and second rates of engagement, and a measure indicative of the effectiveness of the advertisement. The report may contain charts and other visualizations. Additionally or alternatively, the report may include recommendations based on the determined effectiveness.

The process 200 can be used to measure the effectiveness of a static advertisement, e.g., a billboard. Alternatively or additionally, the process 200 can be used to measure the effectiveness of a moving advertisement. For example, the advertisement may be printed on a vehicle or may be shown on a display screen affixed to a moving vehicle. The display screen may be part of a display unit mounted on the exterior portion of the vehicle. The display unit may comprise one or more members selected from the group consisting of a global positioning system (GPS), a wireless transmitter, a wireless receiver, an optical sensor, an audio sensor, an accelerometer, and a gyroscope. The optical sensor may be a camera or video unit. Alternatively or additionally, the optical sensor may be an infrared sensor or an ultraviolet sensor. The optical sensor may be a particle sensor (e.g., a sensor for measuring particles, such as a soot or pollution sensor). The wireless receiver may allow the display screen to communicate with computing devices in a local area. In some instances, the wireless receiver may allow the display unit to download content from one or more connected computing devices, in order to obtain data to provide instructions to the display unit to dynamically adjust or select media content for display.

The media content may be dynamically selected at least in part on the speed, velocity or acceleration of the vehicle along a route, or contextual or environmental factors along the route. The contextual factors may include a geographic location (or geolocation) of the vehicle along the route. The contextual factors may also include a time of day in which the vehicle is travelling the route. The environmental factors may include traffic conditions or ambient lighting along the route. The environmental factors may also include weather conditions along the route. The contextual factors may also include places of interest along the route. The places of interest may include apartments, hotels, museums, parks, shopping centers, restaurants, and bars. The contextual factors may also include entertainment events happening in a vicinity of the route.

Along the route, the vehicle may undergo a change in velocity or acceleration. The media content may be dynamically adjusted in response to the change in velocity or acceleration. Along the route, the vehicle may stop. The content may be adjusted by adopting a faster or slower framerate or rate at which media content is cycled or adjusting its motion in response to the changes in velocity or acceleration, according to events received by an accelerometer or a gyroscope. The display unit may display videos that are shorter in duration or static images when the vehicle moves at a faster speed and play longer content when the vehicle is at a standstill.

The media content may be selected and/or adjusted, and displayed on the display screen automatically without any involvement from a user. As an alternative, the media content may be selected by a user (e.g., through an electronic device of the user in communication with the display screen) and display upon request from the user. The user may be a driver of the vehicle, a remote user, or a passenger of the vehicle.

A sensor may be used to collect audio or video data along the route, and the audio or video data may be used to dynamically select the media content. The sensor may capture a multi-angle video of conditions along the route. The conditions may be route conditions. Further, the display unit may use a sensor to collect geographic data along the route and use the geographic data to dynamically select the media content. Route conditions may include vehicle traffic, pedestrian traffic, visibility, route topography (e.g., hilly, flat, winding roads, dirt road, one-way street), lighting, weather, climate, road conditions, traffic accidents, or other events or conditions external to the vehicle.

The one or more sensors may be used to collect environmental data. The environmental data may include data indicative of visibility along the route. The media content may be adjusted in response to the change in visibility.

One or more environmental conditions may be determined from the environmental data, and the media content may be adjusted in response to the environmental conditions. One or more environmental conditions may include air pollution or light pollution.

Information may be logged along the route, as data is collected from different sources as the vehicle travels along the route. Data may be collected by sensors or by devices that connect to the display unit over a network, such as a Wi-Fi network or a cellular network.

Demographic information may be logged along the route. The logged demographic information may include a number of passengers along the route. The demographic information may include video of pedestrian or vehicle traffic along the route.

The content may be dynamically selected using a machine learning algorithm. For example, a machine learning algorithm may be used to predict the route a vehicle will travel, based on past traveling history. Content may then be allocated by the display unit in response to the predicted route. Example algorithms used may include logistic regression, linear regression, decision trees, and neural networks.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments. In some embodiments, the method 200 may include additional blocks or fewer blocks.

FIG. 3 illustrates an example presentation system 300 (“system 300”) for displaying media content, according to one or more embodiments of the present disclosure. The system 300 may comprise a display unit 302 mountable on an exterior portion of the vehicle. The display unit 302 may include a controller 304 operatively coupled to a display screen 306. The controller 302 may be programmed to dynamically select the media content while the vehicle is travelling along a route; and may also direct the media content dynamically selected to be displayed on the display screen 306.

The controller 304 may be programmed to dynamically select the media content based at least in part on a speed, velocity or acceleration of the vehicle along a route, or contextual or environmental factors along the route.

The system may include a sensor 308 for collecting audio or video data along the route and the audio or video data may be used to dynamically select the media content. The sensor 308 may be a camera that captures a multi-angle video of conditions along the route. The conditions may be route conditions. Further, the display unit 302 may use a sensor 310 to collect geographic data along the route and use the geographic data to dynamically select the media content. Route conditions may include vehicle traffic, pedestrian traffic, visibility, route topography (e.g., hilly, flat, winding roads, dirt road, one-way street), lighting, weather, climate, road conditions, traffic accidents, or other events or conditions external to the vehicle.

The system 300 may include a logging module 312 for storing information collected along the route. The logging module 312 may be a database or data structure. Such information can include passenger information, route information, and/or weather information.

The system may also include a sensor 314 for determining the velocity and acceleration of the vehicle along the route. Further, the system may use a sensor 316 to collect geographic data along the route and use the geographic data to dynamically select the media content. Route conditions may include vehicle traffic, pedestrian traffic, visibility, route topography (e.g., hilly, flat, winding roads, dirt road, one-way street), lighting, weather, climate, road conditions, traffic accidents, or other events or conditions external to the vehicle.

The one or more sensors may be used to collect environmental data. The environmental data may include data indicative of visibility along the route. The media content may be adjusted in response to the change in visibility.

One or more environmental conditions may be determined from the environmental data, and the media content may be adjusted in response to the environmental conditions. One or more environmental conditions may include air pollution or light pollution.

Information may be logged along the route, as data is collected from different sources as the vehicle travels along the route. Data may be collected by sensors or by devices that connect to the display unit over a network, such as a Wi-Fi network or a cellular network.

Demographic information may be logged along the route. The logged demographic information may include a number of passengers along the route. The demographic information may include video of pedestrian or vehicle traffic along the route.

The media content displayed on the display screen 306 may be selected from content stored on an online portal (not illustrated in FIG. 3). The online portal may allow content providers to upload content for playback on the display unit's display screen. The content providers may be allowed to choose a time interval in which to display the uploaded content. The content providers may select a time interval that allows them to target a specific audience. For example, content displayed after midnight near bars may relate to local hotels. The online portal may also allow content providers to choose how often the content is replayed during the time interval. The content providers may be charged additionally for more plays of their content. The online portal may allow content providers to choose a bounded geographic area in which media content playback occurs. The area may be a square, triangular, or arbitrarily-shaped area. The area may be adjusted by the content provider before or during content presentation. The online portal also may allow content providers to collect data about their content as it is being displayed, including data regarding how many impressions the content receives from being displayed to external audiences.

The system 300 may allow users to communicate with connected devices using Wi-Fi and Bluetooth. The system 300 may connect to external devices, such as computing devices, and collect data from these devices over a network. This data may be combined with sensor data to select content for presentation. For example, the system 300 may passively connect data from connected electronic devices including device identifiers and location information. The system 300 may collect location information from Bluetooth Low Energy (BLE) beacons, in densely populated areas GPS information is unavailable or unreliable due to occlusions. The system 300 may allow drivers and passengers to connect using an application and may receive demographic data from the drivers and passengers. The system 300 may be able to stream audio content from a connected Bluetooth device, and play the audio content for one or more external audiences.

Modifications, additions, or omissions may be made to the system 300 without departing from the scope of the present disclosure. For example, the system 300 may include other components and/or other functionality than that described. Additionally or alternatively, the system 300 may omit one or more of the components described with respect to FIG. 3.

### Computing Systems

The present disclosure provides computing systems that are configured to implement the operations described herein. FIG. 4 shows a computing system 401 that is programmed or otherwise configured to determine the effectiveness of an advertisement. The computing system 401 can be an electronic device of a user or a computing system that is remotely located with respect to the electronic device. The electronic device can be a mobile electronic device. In some embodiments, the computing system 401 may be included in or part of the presentation system 300 of FIG. 3. For example, the controller 304 of the presentation system 300 may include at least a portion of the computing system 401. Additionally or alternatively, the system 100 of FIG. 1 may be included with or part of the computing system 401. For example, the group determination subsystem 110 and/or the engagement rate determination subsystem 120 may include the computing system 401 and/or may include computer-readable instructions that may be stored in and executed by the computing system 401.

The computing system 401 includes a central processing unit (CPU, also “processor” and “computer processor” herein) 405 (e.g., processors), which can be a single core or multi core processor, or a plurality of processors for parallel processing. The computing system 401 also includes memory or memory location 410 (e.g., random-access memory, read-only memory, flash memory, electronic storage), electronic storage unit 415 (e.g., hard disk, electronic storage 116), communication interface 420 (e.g., network adapter) for communicating with one or more other systems, and peripheral devices 425, such as cache, other memory, data storage and/or electronic display adapters. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computing system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computing system 401, can implement a peer-to-peer network, which may enable devices coupled to the computing system 401 to behave as a client or a server.

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computing system 401 in some cases can include one or more additional data storage units that are external to the computing system 401, such as located on a remote server that is in communication with the computing system 401 through an intranet or the Internet.

The computing system 401 can communicate with one or more remote computing systems through the network 430. For instance, the computing system 401 can communicate with a remote computing system of a user. Examples of remote computing systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computing system 401 via the network 430.

Methods as described herein can be implemented by way of machine (e.g., computer processor) executable code stored on an electronic storage location of the computing system 401, such as, for example, on the memory 410 or electronic storage unit 415. The machine executable or machine readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 301 can include or be in communication with an electronic display 335 that comprises a user interface (UI) 340 for providing, for example, electronic reports indicative of the effectiveness of an advertisement. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 305. The algorithm can, for example, perform the process 200 of FIG. 2.

As indicated above, the embodiments described in the present disclosure may include the use of a special purpose or general purpose computer including various computer hardware or software modules, as discussed in greater detail below. Further, as indicated above, embodiments described in the present disclosure may be implemented using computer-readable media for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” This interpretation of the phrase “A or B” is still applicable even though the term “A and/or B” may be used at times to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

1. A method for determining an effectiveness of an advertisement, comprising:
obtaining first location data of an advertisement displayed by a moving vehicle, the first location data indicating geographic locations at which the advertisement is displayed and corresponding times as to when the advertisement is displayed at the geographic locations;
determining, based on the first location data, a first time period during which the advertisement is displayed at a specified location;
determining, based on the first location data, a second time period during which the advertisement is not displayed at the specified location, wherein the second time period is disjoint from the first time period by a predetermined difference;
obtaining second location data of respective electronic devices of a plurality of subjects, the second location data indicating geographic locations of the respective electronic devices and corresponding times as to when the respective electronic devices are located at the geographic locations;
identifying, based on the second location data, a target group of the plurality of subjects who were located at the specified location during the first time period such that the target group includes one or more subjects who had an opportunity to view the advertisement during the first time period;
identifying, based on the second location data, a control group of the plurality of subjects who were located at the specified location during the second time period such that the control group includes one or more subjects who did not have an opportunity to view the advertisement during the first time period;
determining a first rate of engagement by the target group with a product, service, or message associated with the advertisement;
determining a second rate of engagement by the control group with the product, service, or message; and
determining an effectiveness of the advertisement using the first rate of engagement by the target group and the second rate of engagement by the control group.

2. The method of claim 1, further comprising outputting a report that is indicative of the effectiveness of the advertisement.

3. The method of claim 1, wherein determining the first rate of engagement or the second rate of engagement comprises determining a proportion of the target group or the control group that engage in an online or offline activity of interest to an advertiser associated with said advertisement.

4. The method of claim 1, wherein determining the first rate of engagement or the second rate of engagement comprises determining a proportion of the target group or the control group that purchased said product, service, or message within a specified period of time.

5. The method of claim 1, wherein determining the first rate of engagement or the second rate of engagement comprises determining a proportion of the target group or the control group that engaged with an online advertisement for said product, service, or message within a specified period of time.

6. The method of claim 1, wherein determining the first rate of engagement or the second rate of engagement comprises determining a proportion of the target group or the control group that visited a point of interest within a specified period of time.

7. The method of claim 1, wherein the predetermined difference is between an end of the first time period and a beginning of the second time period and is at most an hour.

8. A system for determining an effectiveness of an advertisement, the system comprising one or more processors that are individually or collectively programmed to perform operations, the operations comprising:
obtaining first location data of an advertisement displayed by a moving vehicle, the first location data indicating geographic locations at which the advertisement is displayed and corresponding times as to when the advertisement is displayed at the geographic locations;
determining, based on the first location data, a first time period during which the advertisement is displayed at a specified location;
determining, based on the first location data, a second time period during which the advertisement is not displayed at the specified location, wherein the second time period is disjoint from the first time period by a predetermined difference;
obtaining second location data of respective electronic devices of a plurality of subjects, the second location data indicating geographic locations of the respective electronic devices and corresponding times as to when the respective electronic devices are located at the geographic locations;
identifying, based on the second location data, a target group of the plurality of subjects who were located at the specified location during the first time period such that the target group includes one or more subjects who had an opportunity to view the advertisement during the first time period;
identifying, based on the second location data, a control group of the plurality of subjects who were located at the specified location during the second time period such that the control group includes one or more subjects who did not have an opportunity to view the advertisement during the first time period;
determining a first rate of engagement by the target group with a product, service, or message associated with the advertisement;
determining a second rate of engagement by the control group with the product, service, or message; and
determining an effectiveness of the advertisement using the first rate of engagement by the target group and the second rate of engagement by the control group.

9. The system of claim 8, wherein the operations further comprise outputting a report that is indicative of the effectiveness of the advertisement.

10. The system of claim 8, wherein determining the first rate of engagement or the second rate of engagement comprises determining a proportion of the target group or the control group that engage in an online or offline activity of interest to an advertiser associated with said advertisement.

11. The system of claim 8, wherein determining the first rate of engagement or the second rate of engagement comprises determining a proportion of the target group or the control group that purchased said product, service, or message within a specified period of time.

12. The system of claim 8, wherein determining the first rate of engagement or the second rate of engagement comprises determining a proportion of the target group or the control group that engaged with an online advertisement for said product, service, or message within a specified period of time.

13. The system of claim 8, wherein determining the first rate of engagement or the second rate of engagement comprises determining a proportion of the target group or the control group that visited a point of interest within a specified period of time.

14. The system of claim 8, wherein the predetermined difference is effective for satisfying a similarity criterion between the target group and the control group.

15. One or more non-transitory computer-readable media comprising machine-executable code that, upon execution by one or more processors, causes a system to perform operations for determining the effectiveness of an advertisement, the operations comprising:
obtaining first location data of an advertisement displayed by a moving vehicle, the first location data indicating geographic locations at which the advertisement is displayed and corresponding times as to when the advertisement is displayed at the geographic locations;
determining, based on the first location data, a first time period during which the advertisement is displayed at a specified location;
determining, based on the first location data, a second time period during which the advertisement is not displayed at the specified location, wherein the second time period is disjoint from the first time period by a predetermined difference;
obtaining second location data of respective electronic devices of a plurality of subjects, the second location data indicating geographic locations of the respective electronic devices and corresponding times as to when the respective electronic devices are located at the geographic locations;
identifying, based on the second location data, a target group of the plurality of subjects who were located at the specified location during the first time period such that the target group includes one or more subjects who had an opportunity to view the advertisement during the first time period;
identifying, based on the second location data, a control group of the plurality of subjects who were located at the specified location during the second time period such that the control group includes one or more subjects who did not have an opportunity to view the advertisement during the first time period;
determining a first rate of engagement by the target group with a product, service, or message associated with the advertisement;
determining a second rate of engagement by the control group with the product, service, or message; and
determining an effectiveness of the advertisement using the first rate of engagement by the target group and the second rate of engagement by the control group.

16. The computer-readable media of claim 15, wherein the operations further comprise outputting a report that is indicative of the effectiveness of the advertisement.

17. The computer-readable media of claim 15, wherein determining the first rate of engagement or the second rate of engagement comprises determining a proportion of the target group or the control group that engage in an online or offline activity of interest to an advertiser associated with said advertisement.

18. The computer-readable media of claim 15, wherein determining the first rate of engagement or the second rate of engagement comprises determining a proportion of the target group or the control group that purchased said product, service, or message within a specified period of time.

19. The computer-readable media of claim 15, wherein determining the first rate of engagement or the second rate of engagement comprises determining a proportion of the target group or the control group that engaged with an online advertisement for said product, service, or message within a specified period of time.

20. The computer-readable media of claim 15, wherein determining the first rate of engagement or the second rate of engagement comprises determining a proportion of the target group or the control group that visited a point of interest within a specified period of time.
